(19) United States
(12) Patent Application Publication
(10) Pub. No.: US 2025/0033263 A1
(43) Pub. Date: Jan. 30, 2025

(54) INJECTION MOLDING DEVICE AND METHOD

(71) Applicant: Barnes Group Inc., Bristol, CT (US)

(72) Inventors: Vito GALATI, Rowley, MA (US); Fabian KIENZLER, Bristol, CT (US)

(21) Appl. No.: 18/716,762

(22) PCT Filed: Dec. 6, 2022
(86) PCT No.: PCT/US2022/051971

§ 371 Date: Jun. 5, 2024

Related U.S. Application Data
(60) Provisional application No. 63/288,922, filed on Dec. 13, 2021.
(60) Provisional application No. 63/416,801, filed on Oct. 17, 2022.

(51) Int. Cl. B29C 45/76; B29C 45/00; B29C 45/04; B29C 45/77; B29C 45/78; B29L 31/22

(52) U.S. Cl. CPC B29C 45/7646; B29C 45/0017; B29C 45/0046; B29C 45/0408; B29C 45/77; B29C 45/78; B29C 2045/0049; B29C 2945/76006; B29C 2945/7604; B29C 2945/7605; B29C 2945/76257; B29C 2945/76381; B29C 2945/76538; B29C 2945/76939; B29L 2031/22

(57) ABSTRACT

The disclosure is directed to an injection molding device comprising at least one injection mold with a first and second mold half during operation being displaceable with respect to each other in a first direction (z) between a closed position and an open position. The first and second mold halves forming in the closed position at least one cavity therebetween for receiving melted plastic material from an injection nozzle. The at least one cavity comprises first and second cavity sections which are by a constriction. Melted plastic material is injected into the first cavity section and travels from there via the constriction into the second cavity section. A first sensor arrangement is arranged in a cavity wall of the first cavity section and a second sensor arrangement is arranged in a cavity wall of the second cavity section to determine relevant parameters in relation to the constriction.

### FIELD OF THE INVENTION

The disclosure relates to an injection molding device comprising at least one injection mold and a method for quality control of injection molded products, especially injection molded products comprising a constriction.

### BACKGROUND OF THE INVENTION

DE2358911A1 was first published in 1974 on behalf of Anstalt für Verbrennungsmotoren Prof. Dr. List. It relates to a controller for injection moulding machines especially those where the screw is used for plasticising and injection. It comprises a pressure meter for reading the pressure in the mould and a control unit for regulating the injection pressure as a function of this. In addition to the pressure meter, one or more additional meters are used for measuring the flow front speed and/or the temperature in the mould. The injection pressure and/or speed, and in particular the advance speed of the screw during injection, are regulated as a function of these readings.

WO02073328A1 (EP1373999B1) was first published in 2002 on behalf of Priamus System Technologies AG. It relates to method for controlling process parameters in order to obtain constant process conditions. In the operation of filling cavities in an injection mould, the actual profile of the parameter of a cavity being taken as reference and the actual profile of at least one further cavity being compared with it, so that optimum correspondence results in a 45 Degrees straight line or in the event of a lack of correspondence it is aimed to achieve a 45 Degrees straight line by changing the parameters of the further cavity.

WO07006496A1 was first published in 2007 on behalf of Priamus System Technologies AG. It relates to a method for monitoring and/or controlling the melt filling of at least one cavity of an injection molding machine. In particular by means of a cold channel tool. The invention also monitors the time which is required for the melt to reach the sensor in the cavity and modifies the viscosity of the melt in the event of variations and/or differentiations in said time.

WO09040077A1 was first published in 2009 on behalf of Priamus System Technologies AG. It relates to a method for monitoring, documenting and/or controlling an injection molding machine having an injection molding tool into which a melt is introduced. A viscosity of the melt in the injection mold is being ascertained by way of the respective quotients of shear stress and shear rate on the basis of pressure differences, the geometry of the cavity and the flow rate of the melt. The viscosity is ascertained by at least one mold internal pressure sensor and/or at least one mold wall temperature sensor. The pressure difference of the pressure ascertained by the mold internal pressure sensor at it when the melt arrives and at the mold wall temperature sensor when the melt arrives being used for the shear stress and the time that the melt needs to pass from the mold internal pressure sensor to the mold wall temperature sensor being used for ascertaining the flow rate. A device for carrying out the method comprises in a cavity at least one mold wall temperature sensor arranged on the cavity wall at a distance from an entry of the melt and a pressure sensor which is assigned to the injection nozzle of the injection molding machine and/or a hydraulic system of the injection molding machine and/or a hot runner is assigned a pressure sensor.

EP2485881B1 was first published in 2012 on behalf of Priamus System Technologies AG. It relates to a method for regulating the production of a product in a mold into which a plastic compound subjected to a shear rate and/or a shear stress is introduced. The shear rate and/or the shear stress are changed until the product reaches its desired quality such as in particular surface quality, dimension, strength or the like. The shear rate and/or the shear stress for the product with the desired quality is determined wherein the shear rate and/or the shear stress are ascertained by means of pressure sensors and/or temperature sensors. The shear rate and/or the shear stress after reaching the desired quality are kept constant and positions of pressure sensors and temperature sensors are included in the simulation or determination in order to ascertain optimised values of a shear rate and/or a shear stress automatically between the corresponding sensor positions and to store them in a data base.

U.S. Pat. No. 11,010,816B2 was first published in 2017 on behalf of Imflux Inc. It relates to a method of selecting thermoplastic materials for use with an injection molding apparatus that adjusts viscosity of a thermoplastic material based on an interpreted viscosity that is provided. The method includes determining a target MFI for an identified plastic article based on performance properties. A thermoplastic material supply chain is analyzed and a first thermoplastic material having a first starting MFI and a first MFI range is identified and a second thermoplastic material having a second starting MFI and a second MFI range that is greater than the first MFI range is identified and is priced less than the first thermoplastic material. The second thermoplastic material is purchased.

WO18107274A1 was first published in 2018 on behalf of Husky Injection Molding Systems Ltd. It relates to an injection molding apparatus for producing a flip top closure having a body that includes a base and a lid connected by a hinge. The injection molding apparatus comprises an injection unit, a mold fluidly coupled to the injection unit. The mold defining a mold cavity for producing the flip top closure. A heater is placed adjacent to the hinge defining portion, being configured for heating of at least a portion of the hinge defining portion to a continuous temperature during at least a portion of an injection phase and at least a portion of a subsequent cooling phase of molding of the flip top closure in the mold cavity.

U.S. Pat. No. 11,027,470B2 was first published in 2021 on behalf of Coretech Systems Co Ltd. It relates to a molding system which includes a molding machine having a screw and a driving motor driving the screw to move a molding resin. A mold disposed on the molding machine and connected to the barrel of the molding machine to receive the molding resin is having a mold cavity with a die swell structure for being filled with the molding resin. It further includes a processing module simulating a filling process of the molding resin from the barrel into the molding cavity based on a molding condition, including a predetermined screw speed for the molding machine. A controller is operably communicating with the molding machine to control the driving motor of the molding machine based on the molding conditions to move the screw at the predetermined screw speed to transfer the molding resin at a corresponding flow rate to perform an actual molding process for preparing the injection-molded article.

WO21141928A1 was first published in 2021 on behalf of Imflux Inc. It relates to a method and a system for adjusting melt pressure in an injection molding material that allows calculating a melt pressure of a molten plastic material to be injected and based on the calculated melt pressure and a desired melt pressure adjusting operation of an injection molding machine. A method of controlling melt flow front pressure in a co-injection molding apparatus, the method comprising: during a first injection molding cycle, injecting a first material into a mold cavity at a first injection pressure. During the first injection molding cycle, injecting a second material into the mold cavity at a second injection pressure. Determining a first flow front pressure, the first flow front pressure corresponding to the first material. Determining a second flow front pressure, the second flow front pressure corresponding to the second material. During the first injection molding cycle, adjusting the first injection pressure based on comparing the first flow front pressure to a first optimal flow front pressure. During the first injection molding cycle, adjusting the second injection pressure based on comparing the second flow front pressure to a second optimal flow front pressure.

### SUMMARY OF THE INVENTION

The concept of adjusting viscosity of melted plastic material during injection molding to resolve things like balance issues associated with material lot-to-lot MFI (Mold Flow Index) variation using sensors arranged in a cavity is familiar. With the increasing popularity of bioplastic materials, i.e. materials based on bio-degradable materials and/or materials which are based on natural resources, assurance of constant quality becomes more and more important due to variation in material properties and MFI especially with product fulfilling technical functions. During testing of PolyLactic Acid (PLA) applicant found a correlation between viscosity of melted plastic material during injection molding and mechanical properties of the molded parts produced thereby. One aspect of the disclosure is directed to control, respectively improve the mechanical properties such as tensile strength and/or ductility of injection molded parts made from recycled materials and/or bioplastics by adjusting viscosity of the material during the injection molding process. However, especially with recycled materials the mechanical properties are not necessarily solely related to MFI variations, but also related to inclusions of contamination of various types of materials that occurs during the recycling process that potentially also changes the chemical composition of the recycled material.

To calculate shear stress in an appropriate manner, usually two sensors arranged in a cavity are needed. The distance between the sensors is used to calculate the speed of the flow rate, in particular the speed is calculated by dividing the distance between the sensory by a time between two specific signals of the two sensors originating from a melt front in the cavity. The difference of the pressure can be detected when the melt front hits the second sensor. The controller observes the shear stress between two cycles. An absolute value for the shear stress is usually not calculated. As a result, the controller calculates the target barrel temperature for the next cycle. To calculate shear rate of a material during injection a first and a second sensor are arranged functionally interconnected to a cavity. They are usually interconnected to a controller which establishes a functional connection between them to determine the relevant parameters. With respect to a flow path of the liquefied plastic material in a cavity during injection, the second sensor is preferably arranged downstream with respect to the first sensor. An injection nozzle, which discharges into the cavity is usually arranged upstream with respect to the first sensor. For the calculation, usually the functionally significant height of the cavity channel and the distance between the two sensors are considered. The height of the cavity can be understood as a diameter of the cavity in a direction perpendicular to the general direction of the melt flow. Especially in the case of protrusions and/or indentations of a cavity wall, the functionally significant height as input of the necessary calculations is often difficult to determine. Additional quality relevant factors are compression and shear thinning of the melted plastic material. The compression in the final stage of the material injection shall compensate the shrinkage within the holding pressure phase to keep the pressure level at a given level inside the cavity. An input for the cavity is the maximum pressure value of the measurement values in one cycle, compared to the pressure value behind the global maximum. Shear thinning due to increased shear at a constrictions of the cavity should be avoided, as they can lead to degradation of mechanical properties, such as tensile strength or fatigue resistance. Therefore, an optimal viscosity is to be maintained during production, in particular a target viscosity specific to the plastic material and the geometry of the constriction. Viscosity is usually defined as the sheer stress divided by the shear rate.

Processing of the above mentioned bio-materials is often difficult due to volatile material properties in a single batch during production which may result to defective goods if not accounted for. One important aspect is to avoid defective goods especially in case they have to sustain mechanical stress as it occurs with film hinges and the like. In an injection mold often an area which forms in a final product a constriction, e.g. in the form of a film hinge, is a limiting factor. The constriction is usually arranged transversal to a flow path of the material and may therefore disturb the equal distribution of the material during injection. The constriction is often designed as the limiting factor for processing the material or—in case of a test mold—similar to the limiting factor in a production mold. If it can be made sure that in the final product ejected from the injection mold, the mechanical properties of the material in the area of the constriction are sufficiently within certain boundaries it can be assured that the also the rest of the product fulfills the specifications.

An injection molding device according to the disclosure usually comprises an injection mold (mold) with a first mold half and a second mold half which during operation are displaceable with respect to each other in a first direction between a closed position and an open position. The first mold half and the second mold half are forming in the closed position a at least one cavity there between suitable to receive melted plastic material to form after curing a part corresponding to the cavity therein. The cavity usually comprises a first cavity section and a second cavity section which is interconnected to the first cavity section by a constriction. An injection nozzle is in fluid communication with the first cavity section. In the closed position melted plastic material is injected by the injection nozzle into the first cavity section. From there the melted plastic material flows via the constriction into the second cavity section until the cavity is completely filled with the plastic material. After injection in the holding pressure phase the shrinkage of the material is adjusted by adjusting pressure. An injection molding device according to the disclosure can be foreseen for the production of final products or for the production of test products which are having a different shape then the final product, but which are similar to the product with respect to at least one critical area. The test products can be used to e.g. test mechanical properties independent of the final products. In particular, the test mold can be used to determine a set of operating parameters for a specific material, which can be used in an injection molding device to produce molded parts from that specific material having certain mechanical properties.

To control and calculate the relevant parameters as mentioned above, a first sensor arrangement is arranged in a cavity wall of the first cavity section before the constriction. It is communicating with the first cavity section to determine temperature and/or pressure therein and/or position of the melted plastic material while injecting. A second sensor arrangement is arranged—with respect to the flow path of the material—downstream in a cavity wall of the second cavity section behind the constriction. It is communicating with the second cavity section to determine temperature and/or pressure therein and/or position of the melted plastic material while injecting. The first sensor arrangement and the second sensor arrangement are preferably interlinked to a controller configured to determine during injection the viscosity and/or other parameters as mentioned of the melted plastic material in the area of the constriction. Depending on the field of application, the controller is configured to determine the viscosity as a relative value. Thereby it becomes possible to determine the change of the relative viscosity between two injection cycles, in particular between two consecutive cycles, however, the change in viscosity can also be determined between every nth, eg. 10th cycle or even between average values of a certain number of cycles. Good results can be achieved when the first sensor arrangement and the second sensor arrangement comprise a temperature sensor and/or a pressure sensor respectively, such that the viscosity is determined in relation to the temperature and/or the pressure before and after the constriction. In a preferred variation, the controller is configured to maintain the viscosity within a predetermined range of temperature and/or pressure in relation to the geometry of the constriction. Especially when processing biomaterials as mentioned above, the controller is preferably configured to maintain the viscosity depending on the specific plastic material injected, such that a magnitude of an adjustment of the operation is adapted to the specific plastic material, in particular to biologically based and/or recycled plastic materials. The first and the second sensor arrangement are preferably arranged in a symmetric manner with respect to the design of the constriction, especially in lateral direction. Good results can be achieved when the first and the second sensor arrangement are arranged in the middle with respect to the lateral extension of the cavity (with respect to the general direction of the flow).

Especially when forming hinges made from a thin film of plastic material (film hinges), the constriction usually comprises at least one additional thin spot extending transversal with respect to a flow path of the melted plastic material. The thin spot defining a specific hinge axis in the injection molded material after curing. In certain arrangements more than one transversally arranged thin spot can be arranged behind each other to be passed by the material sequentially. The least one thin spot may cause a critical area during processing of the material. One aim of the disclosure is to offer the possibility to control material conditions in the constriction, respectively the additional thin spot as when the conditions do not fit within a defined, material related range of parameters, the resulting film hinges may become brittle or have an insufficient life time. Therefore, the present disclosure offers the possibility to control the critical parameters in an efficient manner. The thin spot forming the film hinge usually spans across the total width of the constriction being arranged traversal with respect to the flow path of the material. Depending on the field of application, the first sensor arrangement usually comprises at least one temperature sensor and/or at least one pressure sensor and the second sensor arrangement comprises at least one temperature sensor and/or at least one pressure sensor. Good results are possible when the first sensor arrangement and the second sensor arrangement are arranged spaced apart a certain distance along a flow path of the melted plastic material between the first and the second sensor arrangement, wherein the distance is e.g. in the range of three to five times the overall length of the constriction in flow direction. A minimal diameter of the cavity is typically a height of the constriction, in particular a height of the thin spot, preferably implemented as a minimal spacing between the first and the second mold halves along the flow path between the first and the second sensor arrangement. The minimal diameter can be less than 5 mm, in particular less than 1 mm, preferably between 0.5 mm and 0.1 mm. Injection molds for the production of hinged products, e.g. such as closures for commercial products or the like, the first and the second cavity section are often interconnected to each other by more than one constriction. These often comprise a first and a second outer hinge strap laterally spaced apart from each other and with respect to a center axis. To obtain a snap effect, the outer hinge straps often comprise two thin spots arranged behind each other and transversal to the flow path of the melted plastic material. Furthermore, an inner hinge strap is arranged on the center axis usually comprising a thin spot arranged transversal to the flow path of the melted plastic material. Depending on the field of application and the intended use, the inner hinge strap or the outer hinge straps can be avoided. In a preferred configuration, one of the outer constrictions may comprise with respect to the flow path of the melted plastic material a first sensor arrangement before the constriction and a second sensor arrangement after the constriction. Alternatively or in addition the inner hinge strap may comprise with respect to the flow path of the melted plastic material a first sensor arrangement before the constriction and a second sensor arrangement after the constriction. Good and balanced results can be achieved when the injection nozzle is arranged on the center axis (axis of symmetry if present). Depending on the design the first sensor arrangement and the second sensor arrangement can e.g. be arranged between 30% to 70% of the lateral width of the respective constriction, in particular 50% (the middle) of the lateral width of the respective constriction. Good results can be achieved, when the first sensor arrangement and the second sensor arrangement are arranged spaced apart a by a distance along the flow path of the melted plastic material, wherein the distance a is in the range of two to five times of a functional length of the constriction. The functional length can be defined as the average length of the channel in which the thin spot is arranged.

Depending on the field of application, the first sensor arrangement and the second sensor arrangement are independently arrangeable with respect to the at least one constriction. In particular, the first sensor arrangement and the second sensor arrangement can be arranged spaced apart by a distance less than two to five times of the functional length of the constriction along the flow path of the melted plastic material. If appropriate, the first sensor arrangement or the second sensor arrangement is arranged in a cavity wall adjacent to or at the constriction. In some variations, both sensor arrangements can be arranged adjacent to or at the constriction, in particular in a parallel manner with respect to a flow path of the melted plastic material. When the second sensor arrangement is arranged at the constriction or adjacent thereto, the first sensor arrangement is preferably arranged a certain distance apart from the constriction, said distance is in particular greater than a diameter of a sensor tip of the first sensor arrangement. Alternatively or in addition, when the first sensor arrangement is arranged at the constriction or adjacent thereto, the second sensor arrangement is preferably arranged a certain distance apart from the constriction, said distance is in particular greater than a diameter of a sensor tip of the second sensor arrangement. The distances of the first sensor arrangement and/or the second sensor arrangement from the constriction can in principle be selected independently from each other.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

The herein described invention will be more fully understood from the detailed description given herein below and the accompanying drawings which should not be considered limiting to the invention described in the appended claims. The drawings are showing:

FIG. 1 a first injection mold;

FIG. 2 a second injection mold;

FIG. 3 a top view of the first injection mold according to FIG. 1;

FIG. 4 a section view along section line FF according to FIG. 3;

FIG. 5 in a top view an arrangement of sensors with respect to a cavity of a hinged product.

### DESCRIPTION OF THE EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

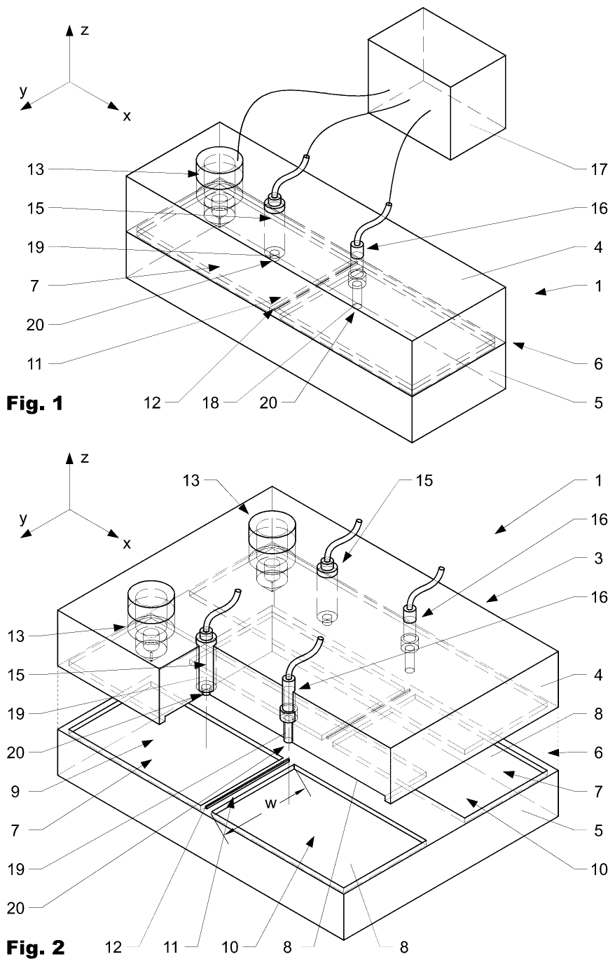

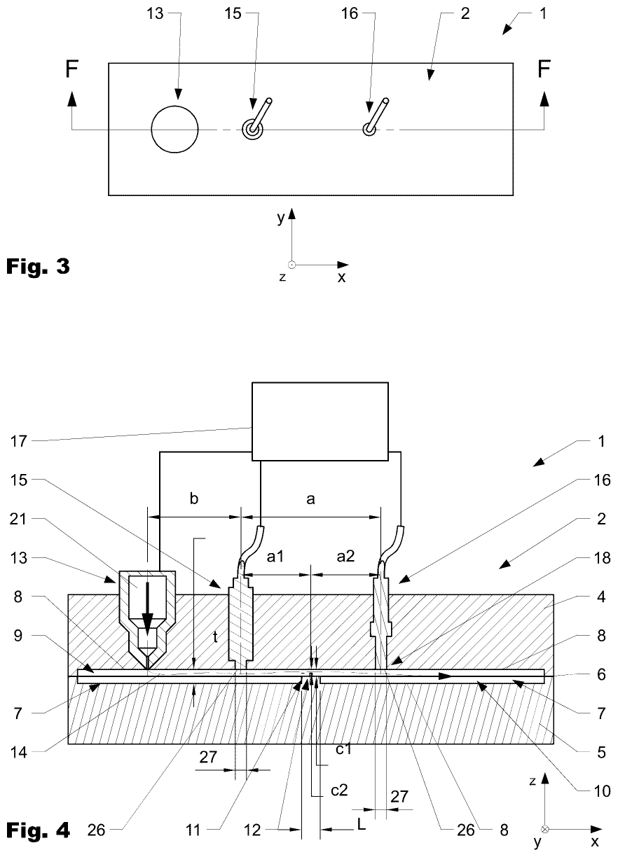

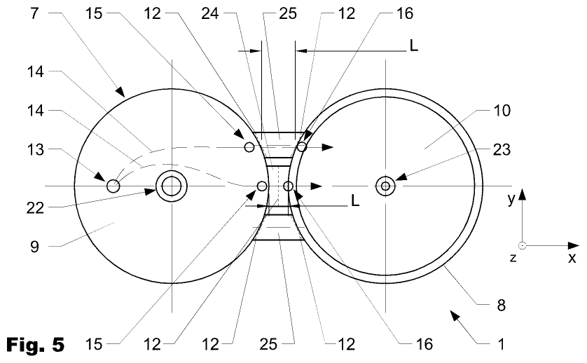

FIG. 1 shows an injection molding device 1 with a first injection mold 2 comprising a single cavity 6. FIG. 2 shows an injection molding device 1 with a second injection mold 3 comprising more than one cavity 7. FIG. 3 shows the first injection mold 2 in a top view and FIG. 4 shows a section view of the first injection mold 2 according to section line FF in FIG. 3. FIG. 5 is schematically showing an arrangement of sensors with respect to a cavity 7 of a hinged product.

An injection molding device 1 usually comprises at least one first injection mold 2 and/or at least one second injection mold 3. Each of the first and/or second injection mold 2, 3 comprises a first mold half 4 and a second mold half 5 which during operation are arranged displaceable with respect to each other in a first direction (z-direction) between a closed position and an open position. The closed position is shown in an exemplary manner in FIG. 1 in accordance with the first injection mold 2 where the first and the second mold halves 4, 5 meet each other along a separation plane 6. The open position is shown in an exemplary manner in FIG. 2 in accordance with the second injection mold 3. The first and the second mold half 4, 5 are space apart from each other in the first direction (z-direction). In addition, the first mold half 4 is partially cut in the front area to provide better visibility. As best visible in accordance with FIG. 1 and FIG. 4, where the first injection mold 2 is shown in the closed position, the first mold half 4 and the second mold half 5 are forming in the closed position at least one cavity 7 there between suitable to receive melted plastic material (not shown in detail) by an injection nozzle 13 opening into the cavity 7. After curing the plastic material forms a part which corresponds to the contour of the cavity 7 and which can be removed after opening the respective injection mold 2, 3. The at least one cavity 7 comprises a first cavity section 9 and a second cavity section 10 interconnected to the first cavity section 9 by a constriction 11. During operation melted plastic material is injected in the closed position of the first, respectively the second injection mold 2, 3 by the respective injection nozzle 13 into the first cavity section 9. From there the material flows across the constriction 11 into the second cavity section 10 until the whole cavity is completely filled. In the shown variations, a first sensor arrangement 15 is arranged in a cavity wall 8 of to the first cavity section 9 and a second sensor arrangement 10 is arranged in a cavity wall 8 of the second cavity section 10. As indicated in FIG. 1 and FIG. 4, the first sensor arrangement 15 and the second sensor arrangement 16 are interlinked to a controller 17 which is configured to determine during injection e.g. the viscosity of the melted plastic material in the area of the constriction 11. Usually the controller 17 is configured to determine the viscosity of material passing the constriction 11 as a relative value of the geometry of the constriction. In a preferred variation, the controller 17 is configured to determine the change of the relative viscosity between two injection cycles. In a preferred variation, the first sensor arrangement 15 and the second sensor arrangement 16 each comprise a temperature sensor 18 and/or a pressure sensor 19. To obtain stable quality during production, the controller 17 can be configured to maintain the viscosity within a predetermined range of temperature and pressure in relation to the geometry of the constriction 10. The controller 17 can be configured to maintain the viscosity depending on the specific plastic material injected, such that a magnitude of an adjustment of the operation is adapted to the specific plastic material, in particular to biological and/or recycled plastic materials. As visible e.g. in FIG. 4 the constriction 10 may comprise at least one additional thin spot 11 further narrowing the cross section and extending essentially transversal with respect to a primary flow path 14 of the melted plastic material 21 injected by the injection nozzle 13. The primary flow path 14 is usually the flow path of the material which first travels across the constriction. The constriction 10 may e.g. comprise at least one geometry for forming a film hinge in the product made from the plastic material received in the cavity 7. In this case, the geometry is implemented as the at least one thin spot 11 spans a total width of the constriction transversal with respect to the flow path 14. The front face 20 of the first and/or the second sensor arrangement 15, 16 may form during operation part of the contour of the cavity wall 8. The first sensor arrangement 15 and the second sensor arrangement 16 are arranged spaced apart by a distance a along the flow path 14 of the melted plastic material 21. The first sensor arrangement 15 is with respect to the primary flow path 14 arranged by a distance a1 upstream the constriction 11 and the second sensor arrangement 16 is arranged by a distance a2 downstream with respect to the constriction 11. The first distance a is preferably in the range of two to five times of the operative length L of the constriction 11, 24, 25. As can be seen from FIG. 4, each sensor arrangement 15, 16 comprises a sensor tip 26. Preferably each sensor tip 26 is embedded in the cavity wall 8. Each sensor tip 26 has a diameter 27, in particular the diameter 27 is measured in the direction of the flow path 14. The distances a1 and a2 can be selected independently from each other and a good control of the viscosity is possible for distances a1 and a2, when their sum is greater than the diameters 27 of the sensor tips 26. If appropriate, the distances a1 and/or a2 can be selected, such that the first sensor arrangement 15 and/or the second sensor arrangement 16 is arranged in a cavity wall 8 adjacent to or at the constriction 11. In other words, the distances a1 and a2 can be essentially zero. When the second sensor arrangement 16 is arranged in the cavity wall 8 at the constriction 11, the first sensor arrangement 15 is preferably arranged a certain distance a1 apart from the constriction 11, said distance a1 is in particular greater than a diameter 27 of a sensor tip 16 of the first sensor arrangement 15. Alternatively or in addition, when the first sensor arrangement 15 is arranged in the cavity wall 8 at the constriction 11, the second sensor arrangement 16 is preferably arranged a certain distance a2 apart from the constriction 11, said distance a2 is in particular greater than a diameter 27 of a sensor tip 26 of the second sensor arrangement 16.

Depending on the field of application the setup may vary. In a preferred variation, the first injection mold 4 is e.g. a test mold with one cavity 7 which is foreseen to produce test samples by which it is possible to determine relevant mechanical parameters of the material in relation to the molding conditions, namely the viscosity determined during injection molding. The second injection mold 5 can be a production mold having at least one cavity 7 which is shaped different then the cavity of the first injection mold 4, but having transferable properties with respect to the critical areas, namely the constriction 10, respectively the thin spot 12, e.g. when forming film hinges. Depending on the field of application, the second injection mold 5 can avoid sensors on the inside and rely on the results of the first injection mold 2 only.

FIG. 5 schematically shows a top view of a cavity 7 of a hinged product. The first and the second cavity section 9, 10 are interconnected to each other by constrictions 11, 24, 25 in the form of a first and a second outer hinge strap (25) laterally spaced apart from each other and a center axis (x) comprising two thin spots 11 arranged behind each other and transversal to the flow path 14 of the melted plastic material. Furthermore, an inner hinge strap 24 is arranged on the center axis (x) comprising a thin spot 11 arranged transversal to the flow path 14 of the melted plastic material. Depending on the field of application and the intended use, the inner hinge strap 24 or the outer hinge straps 25 can be avoided. In the present configuration, one of the outer constrictions 25 comprises with respect to the flow path 14 of the melted plastic material 21 a first sensor arrangement 15 before the constriction 25 and a second sensor arrangement 16 after the constriction 25. Alternatively or in addition the inner hinge strap 24 comprises with respect to the flow path 14 of the melted plastic material 21 a first sensor arrangement 15 before the constriction 24 and a second sensor arrangement 16 after the constriction 24. Good and balanced results can be achieved when the injection nozzle 13 is arranged on the center axis x. Depending on the design the first sensor arrangement 15 and the second sensor arrangement 16 can e.g. be arranged between 30% to 70% of the lateral width of the respective constriction 11, 24, 25, in particular 50% of the lateral width of the respective constriction 11, 24, 25. Good results can be achieved, when the first sensor arrangement 15 and the second sensor arrangement 16 are arranged spaced apart a by a distance a along the flow path 14 of the melted plastic material, wherein the distance a is in the range of two to five times of a functional length L of the constriction 11. The functional length L can be defined as the length of the channel in which the thin spot 12 is arranged.

Rather, the words used in the specification are words of description rather than limitation, and it is understood that various changes may be made without departing from the Spirit and scope of the invention.

LIST OF DESIGNATIONS

| | |
|---|---|
| 1 | Injection molding device |
| 2 | First injection mold |
| 3 | Second injection mold |
| 4 | First mold half |
| 5 | Second mold half |
| 6 | Separation plane |
| 7 | Cavity |
| 8 | Cavity wall |
| 9 | First cavity section |
| 10 | Second cavity section |
| 11 | Constriction |
| 12 | Thins spot (constriction) |
| 13 | Injection nozzle |
| 14 | Flow path (Melted plastic material) |
| 15 | First sensor arrangement |
| 16 | Second sensor arrangement |
| 17 | Controller (sensor arrangements) |
| 18 | Temperature sensor |
| 19 | Pressure sensor |
| 20 | Front face (sensor arrangement) |
| 21 | Melted plastic material (flow path) |
| 22 | Orifice |
| 23 | Pin |
| 24 | Inner hinge strap (constriction) |
| 25 | Outer hinge strap (constriction) |
| 26 | Sensor Tip |
| 27 | Diameter (sensor tip) |

1. Injection molding device (1) comprising
a. at least one injection mold (2, 3) with a first mold half (4) and a second mold half (5) during operation being displaceable with respect to each other in a first direction (z) between a closed position and an open position;
b. the first mold half (4) and the second mold half (5) forming in the closed position at least one cavity (7) there between suitable to receive melted plastic material;
c. the at least one cavity (7) comprising a first cavity section (9) and a second cavity section (10) interconnected to the first cavity section (9) by at least one constriction (11, 24, 25);
d. an injection nozzle (13) opening into the first cavity section (9) in the closed position for injection of melted plastic material (21) into the first cavity section (9) and travels from there via the at least one constriction (11, 24, 25) into the second cavity section (10);
e. wherein a first sensor arrangement (15) is arranged in a cavity wall (8) of to the first cavity section (9) and a second sensor arrangement (16) is arranged in a cavity wall (8) of the second cavity section (10).

2. The injection molding device (1) according to claim 1, wherein the first sensor arrangement (15) and the second sensor arrangement (16) are interlinked to a controller (17) configured to determine during injection the viscosity of the melted plastic material in the area of the constriction (11).

3. The injection molding device (1) according to claim 2, wherein the controller (17) is configured to determine the viscosity as a relative value of the geometry of the constriction (10, 11).

4. The injection molding device (1) according to claim 3, wherein the controller (17) is configured to determine the change of the relative viscosity between two injection cycles.

5. The injection molding device (1) according to claim 1, wherein the first sensor arrangement (15) and the second sensor arrangement (16) each comprise a temperature sensor (18) and/or a pressure sensor (19).

6. The injection molding device (1) according to claim 2, wherein the controller (17) is configured to maintain the viscosity within a predetermined range of temperature and pressure in relation to a geometry of the constriction (10, 11).

7. The injection molding device (1) according to claim 2, wherein the controller (17) is configured to maintain the viscosity depending on the specific plastic material injected, such that a magnitude of an adjustment of the operation is adapted to the specific plastic material, in particular to biological and/or recycled plastic materials.

8. The injection molding device (1) according to claim 1, wherein the constriction (10) comprises at least one thin spot (11, 24, 25) extending transversal with respect to a flow path (14) of the melted plastic material.

9. The injection molding device (1) according to claim 8, wherein the constriction (10) comprises at least one geometry (11) for forming a film hinge in the plastic material received in the cavity (7), in particular the geometry is implemented as the at least one thin spot (11) spanning a total width w of the constriction (10) traversal with respect to the flow path (14).

10. The injection molding device (1) according to claim 8, wherein the constriction (24, 25) comprises at least two thin spots (11) arranged transversal to and in flow path (14) direction behind each other.

11. The injection molding device (1) according to claim 10, wherein the first cavity section (9) and the second cavity section (10) are interconnected to each other by constrictions (24, 25) in the form of
a. a first and a second outer hinge strap (25) laterally spaced apart from each other and a center axis (x) comprising two thin spots (11) arranged behind each other and transversal to the flow path (14) of the melted plastic material
and/or
b. an inner hinge strap (24) arranged on the center axis (x) comprising at least one thin spot (11) arranged transversal to the flow path (14) of the melted plastic material.

12. The injection molding device (1) according to claim 11, wherein at least one of the constrictions (11, 24, 25) comprises with respect to the flow path (14) of the melted plastic material a first sensor arrangement (15) before the constriction (11, 24, 25) and a second sensor arrangement (16) after the constriction (11, 24, 25).

13. The injection molding device (1) according to claim 11, wherein the injection nozzle (13) is arranged on the center axis (x).

14. The injection molding device according to claim 1, wherein the first sensor arrangement (15) and the second sensor arrangement (16) are arranged between 30% to 70% of the lateral width of the respective constriction (11, 24, 25), in particular 50% of the lateral width of the respective constriction (11, 24, 25).

15. The injection molding device according to claim 1, wherein a front face (20) of the first and/or the second sensor arrangement (15, 16) at least partially during operation forms part of a cavity wall (8) of the cavity (7).

16. The injection molding device (1) according to claim 1, wherein the first sensor arrangement (15) and the second sensor arrangement (16) are arranged spaced apart by a distance (a) along a flow path (14) of the melted plastic material, wherein the distance (a) is in the range of two to five times of a functional length L of the constriction (11).

17. The injection molding device (1) according to claim 1, wherein at least one injection mold (2, 3) forming part of the injection molding device (1) is a production mold or a test mold.

18. The injection molding device (1) according to claim 1, wherein the first sensor arrangement (15) and/or the second sensor arrangement (16) is arranged in a cavity wall (8) adjacent to or at the constriction (11, 24, 25).

19. The injection molding device (1) according to claim 18, wherein
a. the first sensor arrangement (15) is arranged a certain distance (a1) apart from the constriction (11, 24, 25), said distance (a1) is preferably greater than a diameter (27) of a sensor tip (26) of the first sensor arrangement (15); and/or
b. the second sensor arrangement (15) is arranged a certain distance (a2) apart from the constriction (11, 24, 25), said distance (a2) is preferably greater than a diameter (27) of a sensor tip (26) of the second sensor arrangement (15).

20. A method for adjusting operation of an injection molding device (1) such that at least one mechanical property of the produced plastic part is within a predefined range, the method comprising the steps of:
a. providing an injection molding device (1) according to preceding claims.
b. determining a viscosity of the melted plastic material (21) during injection based on signals of the first and the second sensor arrangement (15, 16) and a geometry of the cavity (7) at least partially defined by at least one geometric parameter of the constriction (11);
c. adjusting the viscosity based on predetermined reference data defining a target viscosity range for producing plastic parts with the at least one mechanical property in the desired range.

21. Method according to claim 20, wherein the predetermined reference data is ascertained for the geometry of the cavity (7) and/or a specific plastic material by associating viscosity measurements to measurements of the at least one mechanical property of the produced plastic part in the desired range.
